(19) United States
(12) Patent Application Publication
(10) Pub. No.: US 2020/0047858 A1
(43) Pub. Date: Feb. 13, 2020

(54) Y MANIFOLD CAPABLE OF THIRD AXIS MOVEMENT FOR A HYDRO FLIGHT JET BOARD

(71) Applicant: Marat (Mel) Borin, San Antonio, TX (US)

(72) Inventor: Marat (Mel) Borin, San Antonio, TX (US)

(21) Appl. No.: 16/059,133

(22) Filed: Aug. 9, 2018

(51) Int. Cl. B63B 35/73; B63B 35/79; B63H 11/04; B64C 39/02; B63B 35/85

(52) U.S. Cl. CPC B63B 35/731; B63B 35/7943; B63H 11/113; B64C 39/026; B63B 35/85; B63H 11/04

(57) ABSTRACT

A hydro flight jet board comprising of a flexible Y manifold capable of third axis movement, a horizontal rocker arm, pivot hinge and a vertical hinge arm and a thrust unit.

### FIELD OF INVENTION

This invention relates generally to the field of mechanical engineering and is particularly directed to a hydro flight jet board. More specifically, the present invention comprises of a Y manifold capable of third axis movement for a hydro flight jet board or a fly board.

### BACKGROUND OF THE INVENTION

A Flyboard is a brand of hydroflighting device which supplies propulsion to drive the Flyboard into the air to perform a sport known as hydroflying. A Flyboard rider stands on a board connected by a long hose to a watercraft. Water is forced under pressure to a pair of boots with jet nozzles underneath which provide thrust for the rider to fly up to 15 m (49 ft) in the air or to dive headlong through the water down to 2.5 m (8 ft).

The Flyboard is a bolt-on device that is attached to a personal water craft (PWC). It is designed so that the PWC follows behind the rider's trail, allowing the rider multiple degrees of freedom, even allowing the rider to go underwater if they desire. The pilot on the Flyboard is secured in by bindings similar to a wakeboard and the rider is propelled from water jets below the device. The Flyboard is buoyant for safety, which also allows the rider to rest in the water between rides. The use of a personal flotation device and helmet is required by rental locations for safety purposes to protect against serious head trauma in the event of the rider impacting the PWC or stationary structures, and to protect the ears from damage and discomfort from impacts with the water. Device power is controlled by a throttle on the PWC. The equipment may be used in two modes: The primary one requires two people, one to control the PWC throttle which regulates the power and height of the rider. The secondary mode relies on an accessory called an Electronic Management Kit (EMK) which allows the rider to control the PWC throttle

### DISCLOSURE OF PRIOR ART

U.S. Pat. No. 7,182,295 describes various methods, apparatuses, and systems in which an electric-energy lifting panel levitates a user secured to the electric-energy lifting panel. The electric-energy lifting panel includes a first capacitive plate and a second capacitive plate having different geometric dimensions to generate a net-directional force. An ion conditioner ion enhances air around the first capacitive plate and the second capacitive plate. However this prior art patent does not claim the Y manifold capable of third axis movement for a hydro flight jet board or a fly board of the present invention.

U.S. Pat. No. 7,614,355 claims a personal flying water jet apparatus consisting of two autonomous units: one is a towing inflatable tube (12A) (and so on) equipped with water jet nozzles (18) directed downward and mounted on both sides by means of brackets (20); the other is an inlet port (24) fixed on a tow line (16A) and connected with the nozzles (18) by mean of lay flat discharge hose (22). While the tube is being towed, the kinetic head appears and pressurized water is discharged at the nozzles (18) making a thrust, so the rider (10) will fly. Additional versions of the apparatus' performance are possible, such as: Inflatable can be made in the shape of a life jacket (12B) with the nozzles (18) on a Backpack, so the rider (10) will fly in vertical position; water-supply of the nozzles (18) can be realized by means of a water pump (30) mounted on an unmanned tug (14B) connected with the nozzles by means of the hose (22), so the rider (10), while flying, remote controls the propulsion (38), including the driven water pump (30); water-supply of the nozzles (18) can be realized by means of a water pump (30) mounted in a pool (34), so the rider (10) will fly around the pump (30) tied to a rotating swivel fitting (32); the water pump (30) performs like a motor pump (44) and can be mounted directly on the Backpack (12B), but pump inlet is connected to the inlet port (24) (located under the water's surface) by means of the hose (22). However this prior art patent does not claim the Y manifold capable of third axis movement for a hydro flight jet board or a fly board of the present invention.

U.S. Pat. No. 7,258,301 claims a personal propulsion device including a body unit having a center of gravity, where the body unit includes a thrust assembly providing a main conduit in fluid communication with at least two thrust nozzles, with the thrust nozzles being located above the center of gravity of the body unit. The thrust nozzles are independently pivotable about a transverse axis located above the center of gravity, and may be independently controlled by a single common linkage. The present invention may further include a base unit having an engine and a pump, which provides pressurized fluid to the body unit through a delivery conduit in fluid communication with both the base unit and the thrust assembly. However this prior art patent does not claim the Y manifold capable of third axis movement for a hydro flight jet board or a fly board of the present invention.

It is therefore an objective of the present invention to provide a hydro flight jet board or a fly board that is capable of easy and fluid third axis movement.

### OBJECTIVES OF THE INVENTION

The general purpose of the present invention is to provide a hydro flight jet board or a fly board that is capable of easy and fluid third axis movement.

One significant objective of the present invention is to provide a hydro flight jet board that gives an additional directional movement

Another objective of the present invention is to provide a hydro flight jet board that is of a durable rigid construction, yet very lightweight and easy to transport.

Yet another significant objective of the present invention is to provide a hydro flight jet board, whose side to side movement allows for absorption of the hose side to side tugging.

Yet another significant objective of the present invention is to provide a hydro flight jet board which allows the operator to perform maneuvers that previously were not possible.

These and other objects and features of the present invention will be apparent from the following detailed description, taken with reference to the figures of the accompanying drawing.

### SUMMARY OF THE INVENTION

The present invention provides a hydro flight jet board comprising of a flexible Y manifold, a horizontal rocker arm, pivot hinge and a vertical hinge arm and a thrust unit and nozzles therein.

In order to improve the handling of the invention, the nozzles can be advantageously moved forwards in order for the at least one main nozzle to provide the majority of the thrust force to the detriment of the secondary nozzles.

In order to supply the pressurised fluid, in one embodiment, a hydro flight jet board according to the invention can comprise a means for collecting and distributing the pressurised fluid to the nozzles, a means arranged for connecting a fluid supply channel to the hydro flight jet board.

### BRIEF DESCRIPTION OF THE DRAWINGS

FIG. 1 is a perspective view of the present invention.

FIG. 2 is a second perspective view of the present invention.

### DETAILED DESCRIPTION OF THE INVENTION

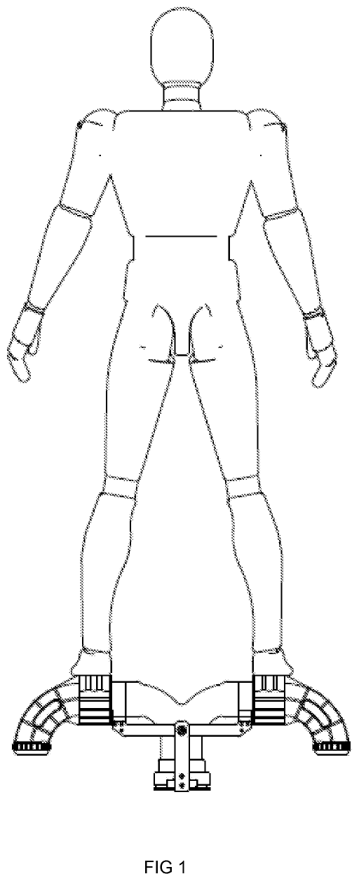

In that form of the present invention chosen for purposes of illustration, FIG. 1 shows the main body of the invention.

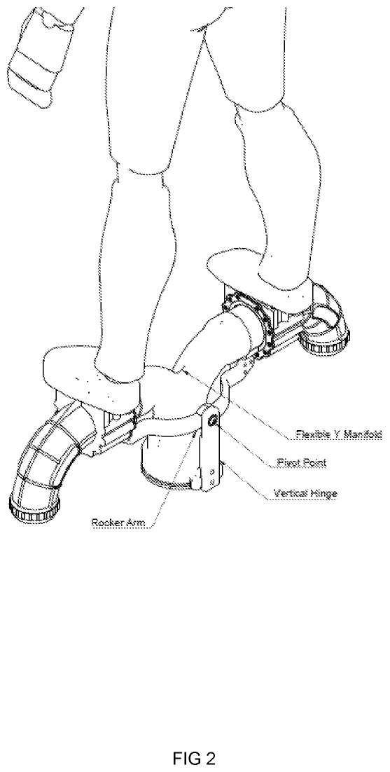

With reference to FIG. 2, the present invention is a hydro flight jet board comprising of a flexible Y manifold, a horizontal rocker arm, pivot hinge and a vertical hinge arm and a thrust unit.

According to a preferred embodiment of the structural arrangement of the present invention, the thrust unit consists of:

at least one main nozzle engaging with the bottom surface of the Y manifold and being positioned according to an axis substantially perpendicular to said bottom surface;
two free secondary nozzles arranged to be held to the foot of the passenger during nominal use of the device below the centre of gravity of the “device-passenger” assembly.

According to a preferred embodiment of the structural arrangement of the present invention, such a unit consists of a single main nozzle attached to the bottom surface of the Y Manifold. In order to assist the take-off of the hydro jet board, the direction of every main nozzle advantageously follows an axis A preferably substantially perpendicular to the bottom surface of the Y Manifold such that a main nozzle expels a pressurised fluid from near the bottom surface of Y manifold and away from same. In order to improve the handling of the hydro jet board, the thrust unit of the hydro jet board also comprises two secondary exit nozzles. These two end exit nozzles that are attached to the Y manifold can only be rotated forward and back in the prior art. The present invention adds an additional directional movement. It creates a 3^{rd} axis and allows for side to side movement. This movement allows for absorption of the hose side to side tugging. This extra movement also allows the operator to perform maneuvers that previously were not possible.

According to a preferred embodiment of the structural arrangement of the present invention, the Y axis manifold comprises on the top surface thereof two slots receiving the feet of a passenger.

According to a preferred embodiment of the working of the present invention, during operation user can lean left or right to move in the desired direction. As the user is flying the Y manifold flexes in the direction of the hose pull thus absorbing the tugging force on the device.

While the preferred embodiments of the present invention has been shown and described in detail, it is to be understood that numerous modifications can be made to the preferred embodiment without departing from the spirit of the invention. For example the flexible Y manifold can be split into several parts where the bottom base is solid but anything above the pivot point is flexible.

Obviously, numerous variations and modifications can be made without departing from the spirit of the present invention. Therefore, it should be clearly understood that the forms of the present invention described above and shown in the figures of the accompanying drawings are illustrative only and are not intended to limit the scope of the present invention.

1. What is claimed is:
A Y manifold capable of third axis movement for a hydro flight jet board, the assembly comprising of
a flexible Y manifold,
a horizontal rocker arm,
a pivot hinge
a vertical hinge arm
a thrust unit and
nozzles
characterized in that
the thrust unit consists of one main nozzle and two secondary or exit nozzles.

2. The Y Manifold as claimed in claim 1 wherein the single main nozzle is attached to the bottom surface of the Y Manifold.

3. The Y Manifold as claimed in claim 1 wherein at least one main nozzle engaging with the bottom surface of the Y manifold and being positioned according to an axis substantially perpendicular to said bottom surface.

4. The Y Manifold as claimed in claim 1 wherein the direction of every main nozzle advantageously follows an axis A preferably substantially perpendicular to the bottom surface of the Y manifold such that a main nozzle expels a pressurised fluid from near the bottom surface of Y manifold and away from same.

5. The Y Manifold as claimed in claim 1 wherein the two exit nozzles that are attached to the Y manifold creates a 3^{rd} axis and allows for side to side movement.

6. The Y Manifold as claimed in claim 1 wherein two exit nozzles are arranged to be held to the foot of the passenger during nominal use of the device below the centre of gravity of the “device-passenger” assembly.

7. The Y Manifold as claimed in claim 1 wherein the Y axis manifold comprises on the top surface thereof two slots receiving the feet of a passenger.

8. The Y Manifold as claimed in claim 1 and working thereof wherein at least one main nozzle engaging with the bottom surface of the Y manifold and being positioned according to an axis substantially perpendicular to said bottom surface.

9. The Y Manifold as claimed in claim 1 and working thereof wherein during operation user can lean left or right to move in the desired direction.

10. The Y Manifold as claimed in claim 1 and working thereof wherein as the user is flying, the Y manifold flexes in the direction of the hose pull thus absorbing the tugging force on the device.

11. The Y Manifold as claimed in claim 1 and working thereof wherein the nozzles can be advantageously moved forwards in order for the at least one main nozzle to provide the majority of the thrust force to the detriment of the secondary nozzles.

12. The Y Manifold as claimed in claim 1 and working thereof wherein the hydro flight jet board according to the invention can comprise a means for collecting and distributing the pressurised fluid to the nozzles, a means arranged for connecting a fluid supply channel to the hydro flight jet board.
